(19) United States
(12) Patent Application Publication
(10) Pub. No.: US 2001/0049719 A1
(43) Pub. Date: Dec. 6, 2001

(54) Method and system for client-server communication

(75) Inventor: Kazuaki Nakajima, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/870,809

(22) Filed: May 31, 2001

(30) Foreign Application Priority Data
May 31, 2000 (JP) 2000-161352

(51) Int. Cl. G06F 15/16

(52) U.S. Cl. 709/203

(57) ABSTRACT

In a client-server system, the browser of a client terminal transmits a first request packet to a server. The server, in response, transmits server specific information to the browser for indicating a server in which shared data file is maintained. The browser responds to the server specific information for invoking the processor of the client terminal to hand over the received information. When invoked, the processor transmits a second request packet to a server specified by the received information to download the shared data file from the server. If the shared data file were transferred to a different server, the server specific information would be updated so that the client terminal can accesses the new server to obtain the data file.

### BACKGROUND OF THE INVENTION

1. Field of the Invention

The present Invention relates to a client-server system which allows client's processors to identify a server on a real-time basis even when data file is moved from one server to another.

2. Description of the Related Art

In the usual plug-in environment in which an external device such as an HTML (hypertext markup language) browser of a client terminal fetches a file from a Web server and uses it to invoke the processor of the client terminal, the file acquisition process is fully entrusted on the browser. As a result, when accessing the server, the invoked client's processor must use the same URL (uniform resource locator) as one that was used by the browser to access the server. However, the ability to ascertain whether the URL specified by the browser is actually available depends on the functions of the browser. As a result, when the client terminal were to sequentially access different servers, the technique for identifying the servers would become too complex to be implemented.

Another method involves writing an URL in a file to be downloaded and using the URL to acquire a different file. However, browser's cache control cannot completely be performed by a processor of the type which is invoked after a file is downloaded. Further, information sharing on a real-time basis cannot consistently be provided. Therefore, it is difficult to guarantee that files which a browser downloads are of most recent origin. In addition, when the client terminal changes servers, it needs to alter the URL of the server information in the file, which represents a time-consuming job. This is a critical problem in a private server environment in which the server if frequently moved from one location to another. Thus, when a server is altered, data cannot simply be transferred.

The approach that is most extensively used as an expedient method is one in which server information is saved in the client terminal. When the client terminal accesses a server, it uses the stored information. However, if the client terminal were to sequentially access different servers, a complex technique would be required to dynamically change servers.

### SUMMARY OF THE INVENTION

It is therefore an object of the present invention to provide a method and a system for allowing client's processors to identify a server on a real-time basis even when data file is moved from one server to another,

According to a first aspect of the present invention, there is provided a method of identifying a server from a client terminal having a browser and a processor, the server and the client terminal being connectable with each other via a communications network, comprising the steps of (a) transmitting a first request packet from the browser to the server, (b) receiving the first request packet at the server and transmitting therefrom server specific information to the browser, indicating a server in which shared data file is maintained, (c) receiving the server specific information at the browser and invoking the processor to hand over the received information to the processor, (d) transmitting a second request packet from the processor to a server specified by the received server specific information, and (e) receiving the second request packet at the specified server and transmitting therefrom the shared data file to the processor

According to a second aspect, the present invention provides a method of identifying a server from a client terminal having a browser and a processor, the server and the client terminal being connectable with each other via a communications network. The method comprises the steps of (a) transmitting a first request packet from the browser to the server, (b) receiving the first request packet at the server and transmitting therefrom server specific information to the browser, indicating a server in which shared data file is maintained, (c) receiving the server specific information at the browser and storing the received information, (d) invoking the processor and transmitting a second request packet therefrom to a server specified by the stored server specific information, and (e) receiving the second request packet at the specified server and transmitting therefrom the shared data file to the processor.

According to a third aspect, the present invention provides a client-server system comprising a communications network, a server connected to the network, and a client terminal connected to the network, the client terminal having a processor and a browser, the browser transmitting a first request packet to the server. The server responds to the first request packet by transmitting server specific information to the browser for indicating a server in which shared data file is maintained. The browser is responsive to the server specific information for invoking the processor to hand over the received information. The processor is responsive to the received information for transmitting a second request packet to a server specified by the received information. The specified server is responsive to the second request packet for transmitting the shared data file to the processor.

According to a fourth aspect, the present invention provides a client-server system comprising a communications network, a server connected to the network, and a client terminal connected to the network, the client terminal having a processor and a browser, the browser transmitting a first request packet to the server. The server is responsive to the first request packet for transmitting a server specific information to the browser for indicating a server in which shared data file is maintained. The browser receives the server specific information and stores it and invokes the processor. The processor reads the stored information and transmits a second request packet to a server specified by the stored information. The specified server is responsive to the second request packet for transmitting the shared data file to the processor.

If the shared data file were transferred from the first server to a second server, the server specific information would be updated by the first server so that the client terminal can accesses the new server to obtain the data file.

### BRIEF DESCRIPTION OF THE DRAWINGS

The present invention will be described in detail further with reference to the following drawings, in which:

FIG. 1 is a block diagram of a client-server system of the present invention; and

FIG. 2 is a flowchart of the operation of the system.

### DETAILED DESCRIPTION

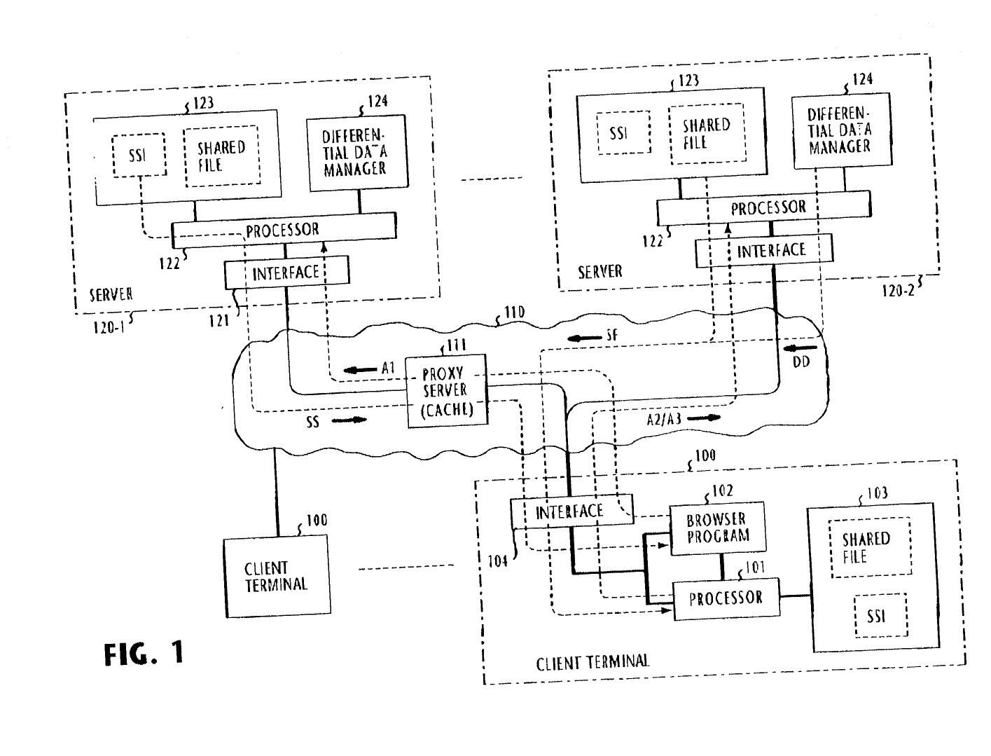

A client-server system of the present invention shown in FIG. 1 comprises a plurality of client terminals 100 connected to the Internet network 110 which includes proxy servers 111. Through the network, each client terminal can access one of a plurality of Web servers 120-1 and 120-2. Each client terminal includes a processor 101, a browser program 102, and a memory device 103 for storing server specific information (SSI) and a shared file which is shared by the accessed server and the requesting client terminal. Processor 101 and browser 102 can individually control a communication device, or interface 104 to access one of the servers directly or via a proxy server in the network. Each server 120 includes an interface 121 connected to the network 110, a processor 122 and a memory device 123 for storing the server specific information of its own server and a shared file. A differential data management unit 124 is connected to the processor 122 for producing differential data. Processor 122 receives HTTP protocol data packet from the network 110 via the interface 121 and takes an appropriate action depending on the type of each packet.

The server specific information stored in the memory device 123 consists of a server address (such as www.server), a server port number (such as 8080), and a variety of server-dependent information which are shared between the server and the client such as download URLs (http:/www.server.8080, for example) and a transfer status flag indicating whether the shared data file is transferred to another server.

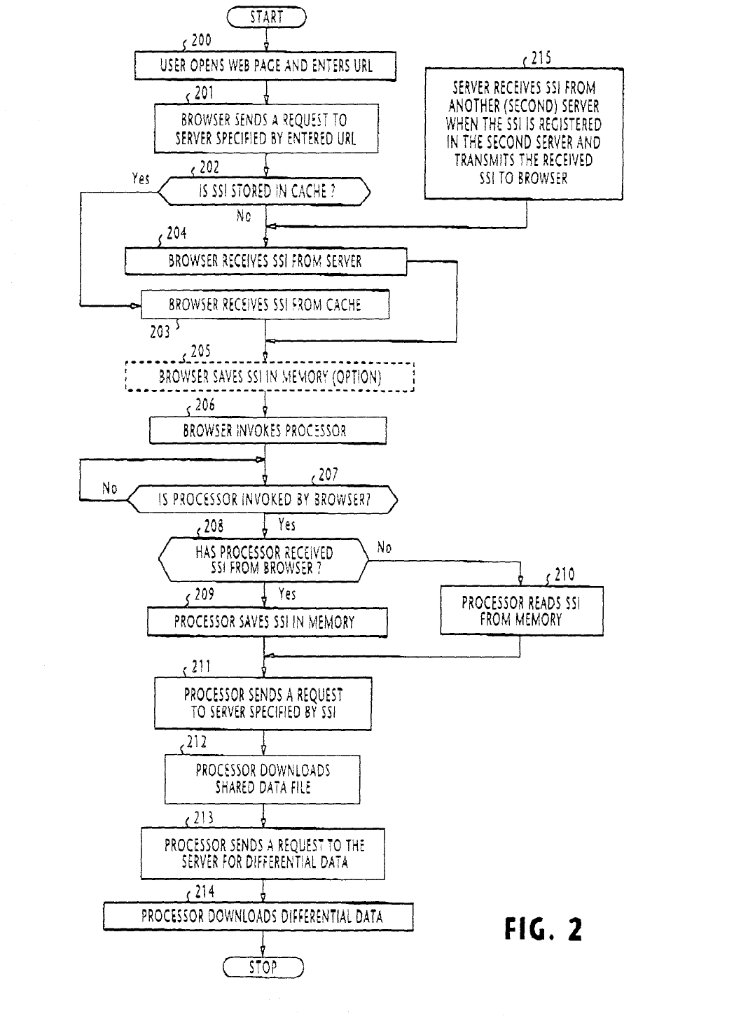

The operation of the client-server system of this invention proceeds according to the flowchart of FIG. 2.

When the user opens a Web page and enters an URL (step 200), the browser 102 sends an HTTP request packet A1 (see FIG. 1) to the network 110. If the request specifies the Web server 120-l, the packet may be routed through the proxy server 111 to the server 210-1 (step 201). The URL of the request packet A1 is http://www.server/datafile.dat, for example. In response, the accessed server sends its server specific information (SSI) to the requesting browser. Browser 102 then checks to see if the server specific information is received from the cache of the proxy server (step 202). If the server specific information of the server 120-1 is previously fetched by the browser 102 or by any other browser in the network and is stored in the cache (step 202), the browser 102 receives the SSI from the proxy server (step 203). If no information is stored in the cache, the browser 102 receives the server specific information from the server 120-1 (step 204). When the browser receives the SSI, it saves it in the memory device 103 (step 205) to be processed later, or proceeds to step 206 to invoke the client's processor 101 in order to hand over the received SSI.

The server accessed by the browser may receive server specific information from another (second) server which belongs to a group of servers when the SSI is registered in the second server (step 215). In this case, the server accessed by the browser sends the received SSI to the browser, which receives it at step 204.

If the client's processor 101 is invoked by the browser (step 207), the processor determines whether SSI is received from the browser. If SSI is received, the processor 101 saves it in the memory device 103 (step 209) and proceeds to step 211. If no SSI is received from the browser, the processor proceeds from step 208 to step 210, recognizing that the browser has executed step 205, and reads the stored SSI from the memory device 103 and proceeds to step 211.

At step 211, the processor 101 recognizes that a Web server specified by the SSI is the server that holds the data file to be shared and sends an HTTP request packet A2 to that server. The URL of the packet A2 contains a path “http://www.server/RealFile_No Cache_{—}12ABCDEF/datafile.dat”, for example. Shared data file is obtained from the server by ignoring the path “RealFile”. Further, “NoCache” is uniquely changed for every access to the server so that no hit occurs in the cache.

If the data file to be shared is resident in the browser-accessed server 120-1, the request packet A2 is routed to the server 120-1. If the shared data file has moved from the server 120-1 to the server 120-2, the SSI sent in response to the previous request packet A1 contains the address of the new server 120-2 and the second request packet A2 is routed to this server as shown in FIG. 1.

In response to a request packet A2, the processor 122 of the accessed server 120-2 recognizes that it is targeted and reads the shared data file (SF) from its memory device 123 and sends it to the network as shown in FIG. 1. The requesting client's processor 101 receives the transmitted file SF and saves it in the memory device 103 (step 212).

If the shared data file is maintained in the browser-accessed server 120-1, the processor 101 sends a request packet A3 to server 120-1 (step 213) for requesting differential data that represents the difference between the data file stored in the server and the data file stored in the client terminal. The URL of the packet A3 is http://server address/differential data exchange character string/shared data file. Differential data manager 124 of the accessed server responds to this request and transmits differential data to the client terminal. The requesting processor downloads the transmitted data into the memory device 103 to update the stored data file (step 214). If the shared data file has been moved to the server 120-2 as described above, the processor 101 sends a request packet A3 to the server 120-2 to request the differential data (DD) as indicated in FIG. 1.

It is seen from the foregoing that the location of a shared file can be changed from one server to another by simply updating the server specific information by changing its server address from the old to the new one. Since the server specific information is sent whenever a server is accessed from a client terminal, the client terminal knows the new location of the shared file and obtains its URL to access the new server on a real-time basis. In addition, there is no need to alter the contents of data file when the data is moved from one server to another.

Further, if the server specific information is saved in the memory device 103 which the browser has received from the server it has accessed (step 205), the saved information can be used by the processor at a later time in a subsequent access to the network in so far as the server has not changed the information content, since the process of acquisition of server specific information by the browser and the process of acquisition of a shared data file by the processor are clearly separated from each other.

What is claimed is:

1. A method of identifying a server from a client terminal having a browser and a processor, said server and said client terminal being connectable with each other via a communications network, comprising the steps of:
a) transmitting a first request packet from said browser to said server;
b) receiving the first request packet at said server and transmitting therefrom server specific information to said browser, indicating a server in which shared data file is maintained;
c) receiving said server specific information at said browser and invoking said processor to hand over the received information to the processor;
d) transmitting a second request packet from the processor to a server specified by the received server specific information; and
e) receiving the second request packet at the specified server and transmitting therefrom said shared data file to said processor.

2. The method of claim 1, wherein the client terminal includes a memory device and the step (e) comprises storing the transmitted shared data file in said memory device, further comprising the step of transmitting a third request packet from said processor to the specified server and transmitting therefrom differential data representing a difference between the shared data file maintained by the server and the shared data file stored in said memory device.

3. The method of claim 1, wherein said network includes a cache memory, and wherein said second request packet contains an identifier identifying said shared data file, said identifier being determined for each access from said processor to said server so that the shared data file identified by said identifier does not coincide with data stored in said cache memory.

4. A method of identifying a server from a client terminal having a browser and a processor, said server and said client terminal being connectable with each other via a communications network, comprising the steps of:
a) transmitting a first request packet from said browser to said server;
b) receiving the first request packet at said server and transmitting therefrom server specific information to said browser, indicating a server in which shared data file is maintained;
c) receiving said server specific information at said browser and storing the received information;
d) invoking the processor and transmitting a second request packet therefrom to a server specified by the stored server specific information; and
e) receiving the second request packet at the specified server and transmitting therefrom said shared data file to said processor.

5. The method of claim 4, wherein the client terminal includes a memory device and the step (e) comprises storing the transmitted shared data file in said memory device, further comprising the step of transmitting a third request packet from said processor to the specified server and transmitting therefrom differential data representing a difference between the shared data file maintained by the server and the shared data file stored in said memory device.

6. The method of claim 4, wherein said network includes a cache memory, and wherein said second request packet contains an identifier identifying said shared data file, said identifier being determined for each access from said processor to said server so that the shared data file identified by said identifier does not coincide with data stored in said cache memory.

7. A client-server system comprising:
a communications network;
a server connected to the network; and
a client terminal connected to the network, the client terminal having a processor and a browser, the browser transmitting a first request packet to said server;
said server being responsive to said first request packet for transmitting a server specific information to said browser for indicating a server in which shared data file is maintained,
said browser being responsive to said server specific information for invoking said processor to hand over the received information thereto,
said processor being responsive to the received information for transmitting a second request packet to a server specified by the received information, and
the specified server being responsive to the second request packet for transmitting said shared data file to said processor.

8. The client-server system of claim 7, wherein the client terminal includes a memory device and the processor is configured to store the shared data file from said specified server in said memory device and transmit a third request packet to the specified server, and wherein the specified server is configured to transmit differential data representing a difference between the shared data file maintained by the server and the shared data file stored in said memory device.

9. The client-server system of claim 7, wherein said network includes a cache memory, and wherein said second request packet contains an identifier identifying said shared data file, wherein said processor is configured to determine said identifier for each access from the processor to said server so that the shared data file identified by said identifier does not coincide with data stored in said cache memory.

10. The client-server system of claim 7, wherein said server is configured to receive server specific information from another server of the network and transmits the received server specific information to said browser.

11. A client-server system comprising:
a communications network;
a server connected to the network; and
a client terminal connected to the network, the client terminal having a processor and a browser, the browser transmitting a first request packet to said server;
said server being responsive to said first request packet for transmitting a server specific information to said browser for indicating a server in which shared data file is maintained,
said browser receiving said server specific information and storing the received information and invoking said processor,
said processor reading the stored information and transmitting a second request packet to a server specified by the stored information, and
the specified server being responsive to the second request packet for transmitting said shared data file to said processor.

12. The client-server system of claim 11, wherein the client terminal includes a memory device and the processor is configured to store the shared data file from said specified server in said memory device and transmit a third request packet to the specified server, and wherein the specified server is configured to transmit differential data representing a difference between the shared data file maintained by the server and the shared data file stored in said memory device.

13. The client-server system of claim 11, wherein said network includes a cache memory, and wherein said second request packet contains an identifier identifying said shared data file, wherein said processor is configured to determine said identifier for each access from the processor to said server so that the shared data file identified by said identifier does not coincide with data stored in said cache memory.

14. The client-server system of claim 11, wherein said server is configured to receive server specific information from another server of the network and transmits the received server specific information to said browser.
